(19) United States
(12) Patent Application Publication
(10) Pub. No.: US 2012/0151054 A1
(43) Pub. Date: Jun. 14, 2012

(54) LOAD BALANCING METHOD FOR CLUSTER SYSTEM

(75) Inventors: He Zhang, Tianjin (CN); Chih-Feng Chen, Taipei (TW)

(73) Assignee: INVENTEC CORPORATION, Taipei (TW)

(21) Appl. No.: 12/965,484

(22) Filed: Dec. 10, 2010

(51) Int. Cl. G06F 15/173

(52) U.S. Cl. 709/225

(57) ABSTRACT

A load balancing method for a cluster system is presented. A load record is firstly established in each server, and the load record has an access connection number of each server. An access channel is then established, and one of the servers is specified as a first server. The first server determines whether the first server specified by the access channel needs to be changed according to the load records. When it is determined that the first server needs to be changed, another server is specified as a second server according to a configuration strategy. The first server sends a reply signal to a user terminal, and the user terminal establishes an access connection with the second server according to the reply signal. Finally, the load records of all the servers are synchronously updated so that all the servers in the cluster system know load conditions of other servers.

### BACKGROUND OF THE INVENTION

1. Field of Invention

The present invention relates to a load balancing method, and more particularly to a load balancing method for a cluster system.

2. Related Art

Generally speaking, in order to provide a higher service bandwidth and availability, a plurality of servers for providing an Internet Small computer system Interface (iSCSI) service usually forms a cluster system, and the cluster system provides the iSCSI service by acting as a whole. The most outstanding feature is that, when a server in the cluster system fails, an application program initially operated by the server can be taken over by other servers.

Basically, as for a currently known cluster system, each of the servers has a physical Internet Protocol (IP) address. A user knows IP addresses of all the servers in the cluster system, and can select any server to perform an access connection. However, when selecting a server for providing the service, the user cannot know a specific access path and load condition of the server for providing the service, and is more likely to select a seriously overloaded server and obtain a very bad service quality and access path. Another server that is not selected may be a best access path with a very light load for the user. In other words, the cluster system does not produce greatest returns in this case.

Therefore, it is an objective currently strived toward by related manufacturers to enable each server in the cluster system to have a balanced load to provide a better service by a method or means.

### SUMMARY OF THE INVENTION

In order to solve the above problems and improve a current load balance strategy that a plurality of servers for providing an iSCSI service forms a cluster system, the present invention is a load balancing method. Access paths of a user terminal are unified by establishing a single access channel, and a server with a low load is selected according to load conditions of the servers, so as to provide the iSCSI service for the user terminal.

In the load balancing method for a cluster system according to the present invention, the cluster system comprises a plurality of servers for providing the iSCSI service, and each of the servers has a physical IP address. A load record is firstly established in each server, and each load record has an access connection number of each of the servers. An access channel is then established, and one of the servers is specified as a first server.

When a user terminal desires to access the cluster system to seek for the service, an iSCSI-established access connection Session Discovery request sent by the user terminal is received. The first server determines whether the first server specified by the access channel needs to be changed according to the load record.

When it is determined that the first server needs to be changed, another server is specified as a second server according to a configuration strategy. The first server sends a reply signal to the user terminal, and the user terminal establishes an access connection with the second server according to the reply signal. When it is determined that the first server does not need to be changed, the first server sends a reply signal to the user terminal, and the user terminal establishes an access connection with the first server according to the reply signal. Finally, the load records of the servers are synchronously updated, so as to enable all the servers in the cluster system to know load conditions of other servers.

Therefore, with the above steps of the present invention, access paths of the user terminal can be unitedly managed by establishing a single access channel, and a configuration strategy is established according to the load conditions of the servers in the cluster system. The configuration strategy determines which server is selected to provide the iSCSI service for the user terminal, so as to provide a best service quality for the user terminal.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a load balancing method for a cluster system according to the present invention;

FIG. 2A is a flow chart of sub-steps of step S16 according to the present invention;

FIG. 2B is a flow chart of sub-steps of step S13 according to the present invention; and

FIG. 3 is a flow chart of sub-steps of step S21 according to the present invention.

### DETAILED DESCRIPTION OF THE INVENTION

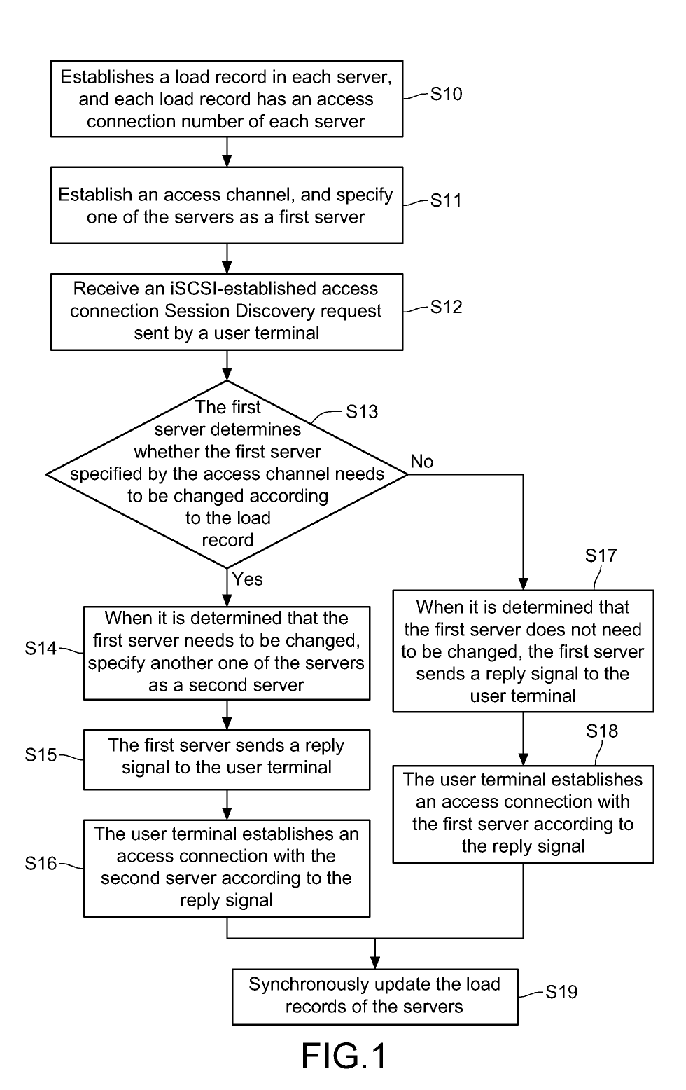

FIG. 1 is a load balancing method for a cluster system according to the present invention. Referring to FIG. 1, the cluster system comprises a plurality of servers for providing the iSCSI service, and each of the servers has a physical IP address. The load balancing method comprises the following steps.

In Step S10, a load record is established in each of the servers, and each load record has an access connection number of each of the servers.

In Step S11, an access channel is established, and one of the servers is specified as a first server.

In Step S12, an iSCSI-established access connection Session Discovery request sent by a user terminal is received.

In Step S13, the first server determines whether the first server specified by the access channel needs to be changed according to the load record.

In Step S14, when it is determined that the first server needs to be changed, another one of the servers is specified as a second server.

In Step S15, the first server sends a reply signal to the user terminal.

In Step S16, the user terminal establishes an access connection with the second server according to the reply signal.

In Step S17, when it is determined that the first server does not need to be changed, the first server sends a reply signal to the user terminal.

In Step S18, the user terminal establishes an access connection with the first server according to the reply signal.

In Step S19, the load records of the servers are synchronously updated, so as to enable all the servers in the cluster system to know load conditions of other servers.

In one embodiment, the access channel is an access IP address. The access IP address may be a virtual IP address or a physical IP address. The virtual IP address is mapped into the physical IP address of the first server.

The reply signal described in step S15 comprises a virtual target name, and each of the servers comprises a target name. The virtual target name is mapped into the target names according to the physical IP address of each of the servers. The virtual target name masks its own target name, and a user cannot see a target name of a server with which the user establishes an access connection.

In brief, when the user desires to access the cluster system, the user cannot know the physical IP addresses of all servers, and only can access one server (that is, the first or the second server described above) in the cluster system and obtain the service from the IP address (either the physical IP address or the virtual IP address) specified by the access channel. When a new user desires to access the cluster system, the server specified as the first server correspondingly selects a suitable server to provide the service according to a configuration strategy, and notifies the user of the IP address of the suitable server to establish an access connection.

The configuration strategy may be set in many manners. For example, the configuration strategy may be arranged according to access connection numbers of each server in the load record, and the server with a smallest access connection number is preferentially appointed as a server for providing the service. It should be noted that the above example is used to exemplify but not to limit the present invention. Persons having ordinary skill should know that the configuration strategy also may appoint a server in the cluster system to provide the service according to priorities, for example, a user with a higher priority is assigned to a specific server, and other users are assigned to other servers.

In addition, since each server has a load record for recording load conditions of all the servers, and load records in all the servers are synchronously updated when each access connection number in the load record changes (for example, when a user establishes an access connection with a server), an effect of load balancing can be effectively achieved, and it can be avoided that a server has users of too many access connection numbers.

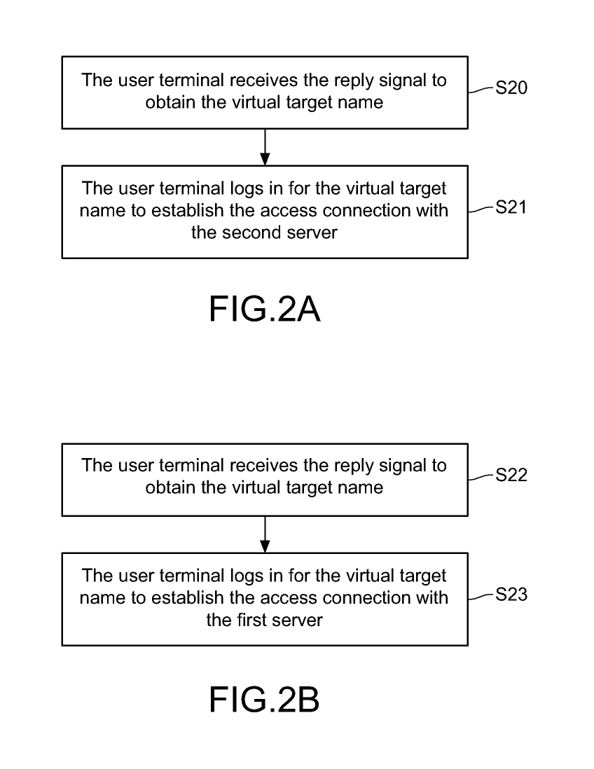

Referring to FIG. 2A, step S16 further comprises the following sub-steps.

In Step S20, the user terminal receives the reply signal to obtain the virtual target name.

In Step S21, the user terminal logs in for the virtual target name to establish the access connection with the second server.

Referring to FIG. 2B, step S13 further comprises the following sub-steps.

In Step S22, the user terminal receives the reply signal to obtain the virtual target name.

In Step S23, the user terminal logs in for the virtual target name to establish the access connection with the first server.

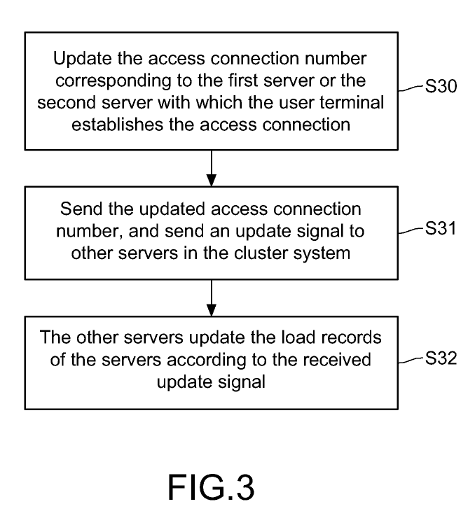

Referring to FIG. 3, step S21 further comprises the following sub-steps.

In Step S30, the access connection number corresponding to the first server or the second server with which the user terminal establishes the access connection is updated.

In Step S31, the updated access connection number is sent, and an update signal is sent to other servers in the cluster system.

In Step S32, the other servers synchronously update the load records of the servers according to the received update signal. Based on the above, access paths of the user terminal can be unitedly managed by establishing a single access channel, and a configuration strategy is established according to the load conditions of the servers in the cluster system. The configuration strategy determines which server is selected to provide the iSCSI service for the user terminal, as so to provide a best service quality for the user terminal.

What is claimed is:

1. A load balancing method for a cluster system, wherein the cluster system comprises a plurality of servers for providing an Internet Small computer system Interface (iSCSI) service, and each of the servers has a physical Internet Protocol (IP) address, the load balancing method comprising:
establishing a load record in each of the servers, and each load record has an access connection number of each of the servers;
establishing an access channel, and specifying one of the servers as a first server;
receiving an iSCSI-established access connection Session Discovery request sent by a user terminal;
determining, by the first server, whether the first server specified by the access channel needs to be changed according to the load record;
specifying another one of the servers as a second server according to a configuration strategy when it is determined that the first server needs to be changed;
sending, by the first server, a reply signal to the user terminal;
establishing, by the user terminal, an access connection with the second server according to the reply signal;
sending, by the first server, a reply signal to the user terminal when it is determined that the first server does not need to be changed;
establishing, by the user terminal, an access connection with the first server according to the reply signal; and
synchronously updating the load records of the servers.

2. The load balancing method according to claim 1, wherein the access channel is an access IP address.

3. The load balancing method according to claim 2, wherein the access IP address is a virtual IP address, and the virtual IP address is mapped to a physical IP address of the first server.

4. The load balancing method according to claim 2, wherein the access IP address is a physical IP address of the first server.

5. The load balancing method according to claim 1, wherein the reply signal comprises a virtual target name, each of the servers comprises a target name, and the virtual target name is mapped to the target names according to the physical IP address of each server.

6. The load balancing method according to claim 5, wherein the step of establishing, by the user terminal, an access connection with the second server further comprises:
receiving, by the user terminal, the reply signal to obtain the virtual target name; and
logging in, by the user terminal, for the virtual target name to establish the access connection with the second server.

7. The load balancing method according to claim 5, wherein the step of establishing, by the user terminal, an access connection with the first server according to the reply signal further comprises:
receiving, by the user terminal, the reply signal to obtain the virtual target name; and
logging in, by the user terminal, for the virtual target name to establish the access connection with the first server.

8. The load balancing method according to claim 1, wherein the step of synchronously updating the load records of the servers comprises:
updating the access connection number corresponding to the first server or the second server with which the user terminal establishes the access connection;
sending the updated access connection number, and sending an update signal to the other servers in the cluster system; and
updating, by the other servers, the load records of the servers according to the received update signal.
